(19) United States
(12) Patent Application Publication
(10) Pub. No.: US 2011/0286311 A1
(43) Pub. Date: Nov. 24, 2011

(54) Calendar mechanism and timepiece equipped with the same

(76) Inventor: Tamotsu Ono, Chiba-shi (JP)

(21) Appl. No.: 13/068,273

(22) Filed: May 6, 2011

(30) Foreign Application Priority Data
May 18, 2010 (JP) 2010-114681

(51) Int. Cl. G04B 19/253

(52) U.S. Cl. 368/38

(57) ABSTRACT

A calendar mechanism includes: a calendar driving wheel equipped with a calendar finger portion rotating a calendar cogwheel portion and a cam portion equipped with a torque reduction shape portion; a lever main body portion rotatably supported on a substrate, a jumper support lever equipped with a cam follower portion following the cam portion, and a jumper operating spring shoe portion provided in an intermediate portion in the longitudinal direction of the lever main body portion and formed on the same side as the cam follower portion with respect to the rotating direction thereof; and a jumper arranged so as to be rotatable with respect to the jumper support lever while overlapping the lever main body portion of the jumper support lever, the jumper being equipped with a jump control finger portion which is directed in a direction opposite to the cam follower portion of the jumper support lever and whose distal end side end portion is pressed against the calendar cogwheel portion by a jumper spring portion locked to the jumper operating spring shoe portion.

### BACKGROUND OF THE INVENTION

1. Field of the Invention

The present invention relates to a calendar mechanism and a timepiece equipped with the same.

2. Description of the Related Art

Well known in the art is a calendar mechanism having a date indicator equipped with a date cogwheel portion, a date indicator driving wheel equipped with a date finger portion rotating the date cogwheel portion, and a date jumper equipped with a jump control finger portion engaged with the date cogwheel portion and pressing the jump control finger portion against the date cogwheel portion and rotatably supported.

In such a calendar mechanism, at the time of jump control operation of the date jumper, the degree to which the date jumper constitutes a rotational load on the date indicator is maximum when the apex portion of a tooth of the date indicator cogwheel portion is got over by the jump control finger portion (immediately before date drop). Thus, in this type of conventional calendar mechanism, there is formed a calendar feeding structure capable of imparting a date feeding torque in excess of the maximum calendar resistance value. On the other hand, when the jump control finger portion is setting the date indicator between two adjacent tooth portions of the date indicator cogwheel portion, the date feeding torque is a minimum possible fixed value, and fluctuation in load increases.

To avoid an excessive increase in rotational load due to the date jumper, it is also known in the art to provide the date indicator driving wheel with a cam portion and to reduce the resistance (rotational load) of the date jumper when the jump control finger portion of the date jumper gets over a tooth of the date indicator cogwheel portion by the cam portion (See, for example, JP-UM-B-5-44793 (Patent Document 1).

In a calendar mechanism as a prior-art technique shown in FIG. 5 of Patent Document 1, as in the case of a calendar mechanism 100 shown in FIG. 10, a date indicator driving wheel 102 is rotated in a direction PB in response to rotation in a direction PA of an hour wheel 101, and a date finger 103a at the distal end of a date wheel 103 capable of elastic deformation rotates a calendar feeding pinion 107 in a direction PC in response to the rotation in the direction PB of the date indicator driving wheel 102, causing a date indicator 108 to rotate in a direction PD via the calendar feeding pinion 107. At the time of rotation in the direction PD of the date indicator 108, a date jumper main body 110 in the form of a lever rotatable around a jump control lever shaft 109 performs jump control operation with a jump control finger portion 110a. The date jumper main body 110 receives an elastic biasing force in a direction PE from a jump control lever contact portion 111c at the distal end of a spring portion 111a of a jump control lever spring 111 rotatable around a lever spring shaft 112. On the other hand, a cam contact portion 111b constituting a cam follower of the jump control lever spring 111 abuts a circular (cylindrical) cam surface 104b in the outer periphery of the cam portion 104 of the date feeding wheel 102. The cam surface 104b of the cam portion 104 is equipped with a load reduction recess 104a.

That is, in the calendar mechanism 100, a date jumper 120 is composed of the date jumper main body 110 and the spring mechanism or jump control lever spring 111; when the date jumper main body 110 is rotated in a direction opposite to the direction PE around a rotation shaft 109 at the time of the jump control finger portion 110a of the date jumper main body 110 getting over a tooth portion 108a of a date indicator cogwheel portion 108b, the cam follower 111b of the spring mechanism 111 imparting a spring load to the date jumper main body 110 just drops into a recess 104a of the cam 104 of the date indicator driving wheel 102, and the spring mechanism 111 as a whole is rotated in a direction PF around a rotation shaft 112 thereof, and the jump control lever contact portion 111c of the spring mechanism 111 pressing the rear of the date jumper main body 110 also escapes. As a result, it is possible to suppress an increase in the load when the date jumper 120 gets over the tooth 108a of the date indicator cogwheel portion 018b.

However, in the calendar mechanism 100, the date jumper 120 is composed of the two separate components: the date jumper main body 110 and the spring mechanism 111, which are arranged two-dimensionally with respect to each other and scanned two-dimensionally, with the result that the scanning region of the date jumper 120 increases, and the operational region for the other components is restricted. Further, since the spring mechanism 111 assumes a complicated configuration and arrangement, a rather bothersome design is inevitable. Further, the distance (arm length) between the cam contact portion constituting the cam follower and the lever spring shaft 112 and the distance (arm length) between the jump control lever contact portion 111c and the lever spring shaft 112 is inevitably approximately the same, so that the protruding and recessed configuration of the cam portion cannot but be small, and there is a fear of the component cost becoming too high to neglect.

### SUMMARY OF THE INVENTION

It is an aspect of the present application to provide a calendar mechanism capable of reducing a torque load due to a spring portion of a jumper while keeping a minimum occupation area, and a timepiece equipped with such a calendar mechanism.

According to the present application, there is provided a calendar mechanism comprising: a calendar wheel equipped with a calendar cogwheel portion; a calendar driving wheel equipped with a calendar finger portion rotating the calendar cogwheel portion and a cam portion rotating coaxially with the finger portion; a jump support lever equipped with a lever main body portion whose lever proximal end portion is rotatably supported on a substrate, a cam follower portion formed on one side of a distal end portion of the lever main body portion and following the cam portion, and a jumper operating spring shoe portion provided in an intermediate portion between a distal end portion and a proximal end portion in the longitudinal direction of the lever main body portion, with the cam follower portion and the jumper operating spring shoe portion being formed on the same side of the lever main body portion with respect to the rotating direction of the lever main body portion; and a jumper arranged so as to be rotatable with respect to the jumper support lever while overlapping the lever main body portion of the jumper support lever, the jumper being equipped with a jump control finger portion directed in a direction opposite to the cam follower portion of the jumper support lever with respect to the rotating direction of the lever main body portion and engaged with the calendar cogwheel portion and a jumper spring portion pressing the jump control finger portion against the calendar cogwheel portion, a distal end side end portion of the spring portion of the jumper being locked to the jumper operating spring shoe portion of the jumper support lever, wherein the cam portion of the calendar driving wheel is equipped with a torque reduction shape portion so as to reduce the spring load of the jumper spring portion when the jump control finger portion of the jumper gets over a tooth portion constituting the calendar cogwheel portion.

In the calendar mechanism of the present application, “the cam portion of the calendar driving wheel is equipped with a torque reduction shape portion so as to reduce the spring load of the jumper spring portion when the jump control finger portion of the jumper gets over the tooth portion constituting the calendar cogwheel portion,” so that it is possible to reduce the torque load due to the jumper spring portion. Further, in the calendar mechanism of the present invention, in addition to “a calendar driving wheel equipped with a calendar finger portion rotating the calendar cogwheel portion and a cam portion rotating coaxially with the finger portion,” there is provided “a jump support lever equipped with a lever main body portion whose lever proximal end portion is rotatably supported on a substrate, a cam follower portion formed on one side of a distal end portion of the lever main body portion and following the cam portion, and a jumper operating spring shoe portion provided in an intermediate portion between a distal end portion and a proximal end portion in the longitudinal direction of the lever main body portion,” and “a jumper equipped with a jump control finger portion engaged with the calendar cogwheel portion and a jumper spring portion pressing the jump control finger portion against the calendar cogwheel portion” is “arranged so as to be rotatable with respect to the jumper support lever while overlapping the lever main body portion of the jumper support lever, and a distal end side end portion of the spring portion of the jumper is locked to the jumper operating spring shoe portion of the jumper support lever,” so that the jumper can actually conduct jump control operation within the range of expansion and operation of the jumper support lever; thus, by securing the requisite region for rotational scanning of the jump support lever, it is possible to reduce the torque load due to the spring portion of the jumper, so that it is possible to minimize the occupation area.

In this case, the design of the spring force of the jumper spring, etc. can be facilitated.

Further, in the calendar mechanism of the present application, “the cam follower portion and the jumper operating spring shoe portion of the jumper support lever are formed on the same side of the lever main body portion with respect to the rotating direction of the lever main body portion,” so that the reduction in occupation area is effectively achieved; further, in addition to this, the jump control finger portion of the jumper is “directed in a direction opposite to the cam follower portion of the jump support lever with respect to the rotating direction of the lever main body portion and engaged with the calendar cogwheel portion,” so that not only does the spring portion of the jumper regulates the jump control operation of the jumper, but also regulates the following of the cam portion by the cam follower portion of the jump support lever, so that the structure can be simplified to a maximum degree.

Typically, in the calendar mechanism of the present application, the jump support lever is equipped with a jump rotation support portion, and the jumper is rotatably supported by the jumper rotation support portion of the jumper support lever.

In this case, the jumper can be supported at a desired position of the jumper support lever (typically, a position in the vicinity of a proximal end portion at which the lever itself is rotatably supported), and the jump control finger portion can be easily set at a position suitable for suppressing the torque load at a desired level when the jump control finger portion performs jump control operation on the calendar wheel cogwheel portion. However, if so desired, the rotation center of the jumper may coincide with the rotation center of the jump support lever. In this case, the jumper may be rotatably supported by the jumper rotation support portion of the jumper support lever; instead, however, the jumper may be directly supported by the substrate so as to be rotatable (For example, it is possible to insert a protrusion-like shaft portion protruding from a substrate such as a main plate into the bearing hole of the jumper support lever and the bearing hole of the jumper to rotatably support the jumper support lever and the jumper). When the rotation center of the jumper support lever and the rotation center of the jumper are deviated from each other, it is possible to easily select various manners in which the jump control finger portion of the jumper is displaced with respect to the calendar wheel cogwheel portion).

Typically, in the calendar mechanism of the present application, the jumper support lever is equipped with the jumper rotation support portion in the vicinity of the proximal end portion of the lever main body portion, and is equipped with a jumper operating spring shoe portion in the intermediate portion between the forward end portion of the lever main body portion and the jumper rotation support portion with respect to the longitudinal direction of the lever; and the jumper is equipped with a jump control finger portion between the distal end portion and the proximal end portion of the lever main body portion with respect to the longitudinal direction of the lever main body portion and on the side opposite to the jumper operating spring shoe portion with respect to the width direction of the lever main body portion.

In this case, the cam follower portion which is at the distal end portion of the lever main body portion and whose arm length is relatively large can be displaced more greatly than the jumper operating spring shoe portion and the jump control finger portion which are situated at the intermediate portion in the longitudinal direction of the cam follower portion and whose arm length is relatively small, so that it is possible to enlarge changes in the configuration of the cam portion of the calendar driving wheel. Thus, it is easily possible to reliably conduct the jump control operation by the jumper while suppressing an increase in the torque load.

Typically, in the calendar mechanism of the present application, the jumper is equipped with a thin and narrow jumper main body portion, and is rotatably supported by the jumper rotation support portion at the proximal end portion of the jumper main body portion; and the jumper spring portion is curved into a U-shape from the proximal end portion of the jumper main body portion to extend along one side portion of the jumper main body portion, and the jump control finger portion is formed on the other side portion of the distal end portion of the jumper main body.

In this case, with the spring portion being of a relatively simple configuration, it is possible to cause both the cam follower portion of the jumper support lever and the jump control finger portion of the jumper to perform a desired operation.

Typically, in the calendar mechanism of the present application, the cam portion is equipped with a partial annular surface portion and a recess recessed radially inwards from the annular surface portion to function as the torque reduction shape portion; and, when the jump control finger portion of the jumper climbs the apex of one tooth portion of the calendar cogwheel portion, the cam follower portion of the jumper support lever is fitted into the recess of the cam portion.

In this case, by determining the peripheral expansion and depth of the recess of the cam portion and the configuration of the side surface of the recess from the partial annular surface portion to the bottom portion of the recess (peripheral expansion and inclination), it is possible to determine the manner in which the torque load is reduced by the jumper spring portion. Since it also depends on the configuration of the tooth portions constituting the calendar wheel cogwheel portion and the configuration of the trough portion between the adjacent tooth portions, balancing is made with respect to the configuration as desired.

Typically, in the calendar mechanism of the present application, after the jump control finger portion of the jumper starts to climb one tooth portion of the calendar cogwheel portion, the cam follower portion of the jumper support lever starts to be fitted into the recess of the cam portion.

In this case, on the one hand, it is possible to suppress an excessive increase in torque load, and, on the other hand, to avoid a temporary reduction in the torque load before the increase in the torque load. Of course, it is possible for the cam follower portion of the jumper support lever to start to be fitted into the recess of the cam portion practically simultaneously with the start of climbing of the jump control finger portion of the jumper on one tooth of the calendar wheel cogwheel portion; however, if there is any variation, there is a fear of the characteristics being reversed, so that, typically, the above construction is adopted.

Typically, in the calendar mechanism of the present application, after the jump control finger portion of the jumper has completely got over one tooth portion of the calendar cogwheel portion and has been fitted into the interval between the next pair of tooth portions to complete the setting of the calendar cogwheel portion, the cam follower portion of the jumper support lever starts to escape from the recess of the cam portion.

In this case, it is possible to avoid a further enhancement of the load when the torque load has been increased before the jump control finger portion of the jumper has completely got over one tooth portion of the calendar wheel cogwheel portion, making it easier to reliably achieve a reduction in torque load.

Typically, in the calendar mechanism of the present application, the calendar wheel and the calendar cogwheel portion are respectively a date indicator and a date cogwheel portion; the calendar driving wheel and the calendar finger portion are respectively a date indicator driving wheel and a date finger; the jumper support lever and the jumper operating spring shoe portion are respectively a date jumper support lever and a date jumper operating spring shoe portion; and the jumper is a date jumper.

In this case, the operation of the date indicator as the calendar wheel can be easily and reliably controlled with a small occupation area. In this case, it is possible to reduce the requisite torque for causing the date jumper to perform jump control operation, so that even in a case where the maximum torque permitted at the time of date change of the calendar wheel, it is also possible, for example, to feed the date indicator and the day indicator simultaneously.

To achieve the above aspect, a timepiece according to the present application is equipped with a calendar mechanism as described above.

### BRIEF DESCRIPTION OF THE DRAWINGS

FIG. 1 shows an explanatory plan view, partly in section, of a part of a timepiece according to a preferred embodiment of the present invention equipped with a calendar mechanism according to a preferred embodiment of the present invention (In the section, a date indicator situated in front of a lever is indicated by a phantom line);

FIG. 2 shows an explanatory sectional view of a portion of the timepiece of FIG. 1;

FIGS. 3A and 3B show diagrams illustrating a part of the operation state of the calendar mechanism of the timepiece of FIG. 1, of which FIG. 3A is an explanatory plan view, substantially similar to FIG. 1, illustrating an operation state a little advanced as compared with the operation state of FIG. 1 (where the date indicator situated in front of the lever is indicated by the phantom line (which also applies to the following drawings)), and FIG. 3B is an explanatory plan view, similar to FIG. 3A, illustrating an operation state a little advanced as compared with that of FIG. 3A;

FIGS. 4A and 4B show diagrams illustrating another part of the operation state of the calendar mechanism of the timepiece of FIG. 1, of which FIG. 4A is an explanatory plan view, substantially similar to FIG. 3B, illustrating an operation state a little advanced as compared with the operation state of FIG. 3B, and FIG. 4B is an explanatory plan view, similar to FIG. 4A, illustrating an operation state a little advanced as compared with that of FIG. 4A;

FIGS. 5A and 5B show diagrams illustrating still another part of the operation state of the calendar mechanism of the timepiece of FIG. 1, of which FIG. 5A is an explanatory plan view, substantially similar to FIG. 4B, illustrating an operation state a little advanced as compared with the operation state of FIG. 4B, and FIG. 5B is an explanatory plan view, similar to FIG. 5A, illustrating an operation state a little advanced as compared with that of FIG. 5A;

FIGS. 6A and 6B show diagrams illustrating yet another part of the operation state of the calendar mechanism of the timepiece of FIG. 1, of which FIG. 6A is an explanatory plan view, substantially similar to FIG. 5B, illustrating an operation state a little advanced as compared with the operation state of FIG. 5B, and FIG. 6B is an explanatory plan view, similar to FIG. 6A, illustrating an operation state a little advanced as compared with that of FIG. 6A;

FIGS. 7A and 7B show diagrams illustrating yet another part of the operation state of the calendar mechanism of the timepiece of FIG. 1, of which FIG. 7A is an explanatory plan view, substantially similar to FIG. 6B, illustrating an operation state a little advanced as compared with the operation state of FIG. 6B, and FIG. 7B is an explanatory plan view, similar to FIG. 7A, illustrating an operation state a little advanced as compared with that of FIG. 7A;

FIGS. 8A and 8B show diagrams illustrating yet another part of the operation state of the calendar mechanism of the timepiece of FIG. 1, of which FIG. 8A is an explanatory plan view, substantially similar to FIG. 7B, illustrating an operation state a little advanced as compared with the operation state of FIG. 7B, and FIG. 8B is an explanatory plan view, similar to FIG. 8A, illustrating an operation state a little advanced as compared with that of FIG. 8A;

FIG. 9 shows a torque change explanatory view illustrating the relationship between the change in operation state and the rotational load torque of a date indicator driving wheel until the calendar mechanism of the timepiece of FIG. 1 attains the state of FIG. 8A or FIG. 8B from the state of FIG. 1, FIG. 3A or FIG. 3B; and

FIG. 10 shows an explanatory plan view, substantially similar to FIG. 1, of a conventional calendar mechanism.

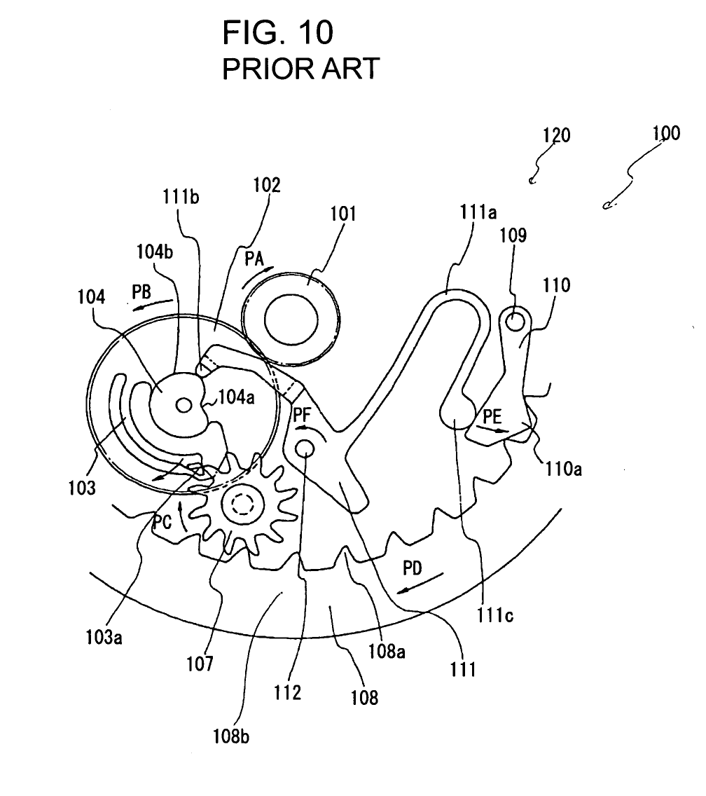

### DESCRIPTION OF THE PREFERRED EMBODIMENTS

A preferred mode of carrying out the present invention will be described with reference to a preferred embodiment shown in the accompanying drawings.

### Embodiment

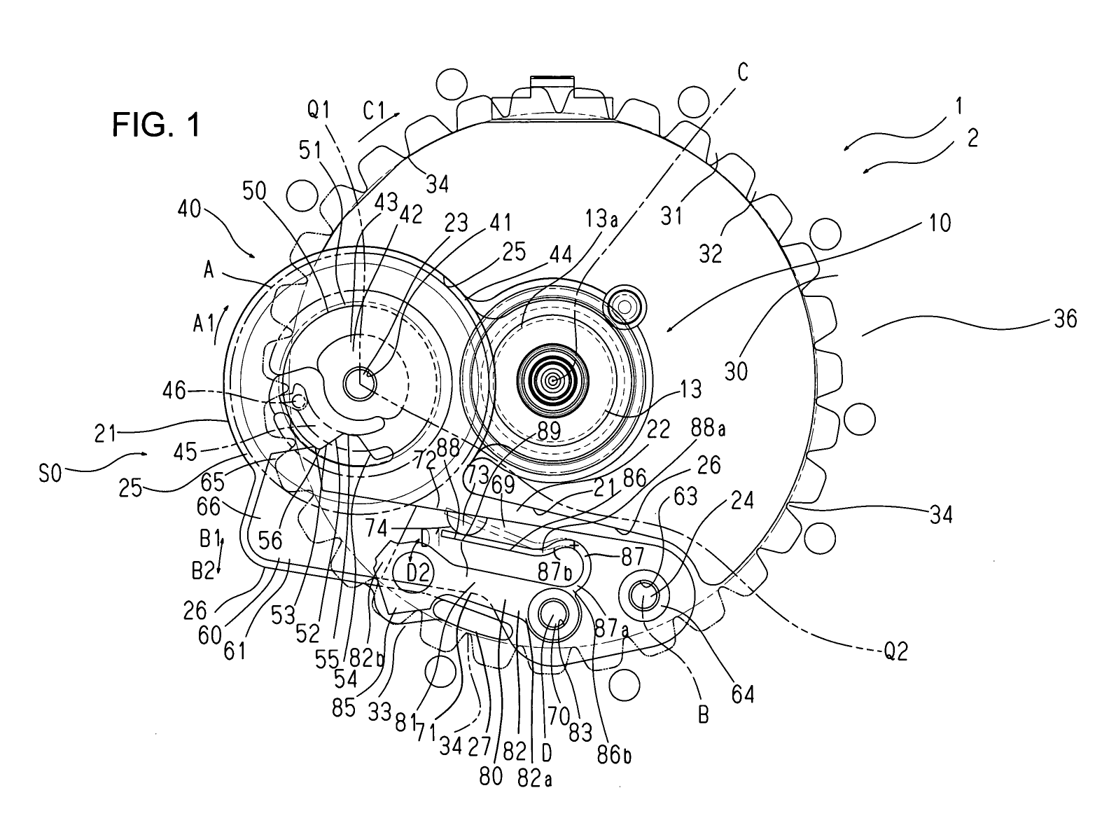

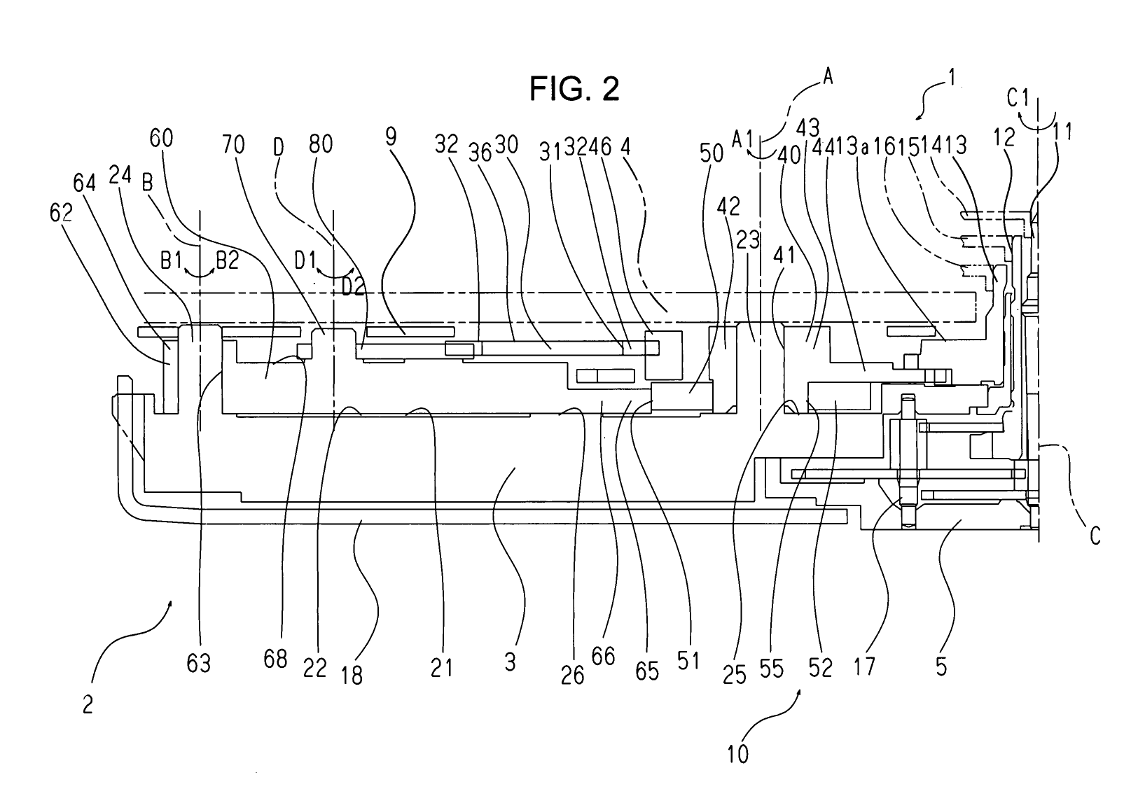

As can be seen from FIG. 1, which illustrates the outline of a calendar mechanism 1 in plan view, and FIG. 2, which shows in section a part of a timepiece 2, the timepiece 2 equipped with the calendar mechanism 1 of a preferred embodiment of the present invention is equipped with the calendar mechanism 1 on a dial 4 side of a main plate 3.

The timepiece 2 is equipped with a timepiece train wheel 10 rotatably supported by the main plate 3 and a train wheel bridge 5 and enabling time indication along a center axis C or near the center axis C. The timepiece train wheel 10 includes a second wheel & pinion 11, a center wheel & pinion 12, and an hour wheel 13 arranged coaxially around the center axis C. A second hand 14, a minute hand 15, and an hour hand 16 are attached to the distal end portions, protruding from a center hole of the dial 4, of the respective shafts or arbors of the second wheel & pinion 11, the center wheel & pinion 12, and the hour wheel 13. The second wheel & pinion (second indicator) 11 and the center wheel & pinion (minute indicator) 12 are connected together by a third wheel & pinion 17, and the center wheel & pinion 12 and the hour wheel (hour indicator) 13 are connected together by a minute wheel (not shown).

On the case back (not shown) side of the main plate 3, there extends a battery positive terminal 18, providing a reference potential for power supply from a battery (not shown) serving as a drive source of a timepiece motor (not shown), a crystal oscillator (not shown), etc. The timepiece 2 may also be a mechanical timepiece utilizing the energy of a mainspring.

A cogwheel portion 13a of the hour wheel 13 is connected with the calendar mechanism 1.

The calendar mechanism 1 has a date indicator 30 as a calendar wheel, a date indicator driving wheel 40 as a calendar driving wheel, a date jumper support lever 60 as a jumper support lever, and a date jumper 80.

On the front surface opposed to the dial 4, the main plate 3 is provided with a recess 21 permitting the operation of the date indicator driving wheel 40 and the date jumper support lever 60, and is equipped with a date indicator driving wheel rotation support shaft portion 23 and a date jumper support lever rotation support shaft portion 24 protruding from a bottom surface 22 of the recess 21. Of the recess 21, around the date indicator driving wheel rotation support shaft portion 23, there is formed a substantially circular date indicator driving wheel rotation permitting region defining recess 25; and, of the recess 21, around the date jumper support lever rotation support shaft portion 24, there is formed a substantially circular date indicator driving wheel rotation permitting region defining recess 26. Numeral 27 indicates a date indicator guide protrusion formed on the surface of the main plate 3 in order to guide the rotation of the date indicator 30.

The date jumper support lever rotation support shaft portion 24 is situated in the vicinity of the inner peripheral edge of the date indicator 30. In this example, the date indicator driving wheel rotation support shaft portion 23 is situated at the 12 o'clock position of the timepiece 2, and the date jumper support lever rotation support shaft portion 24 is situated substantially at a position between 8 o'clock and half past eight of the timepiece 2.

The date indicator 30 as the calendar wheel is substantially of an annular configuration, and is equipped with a date cogwheel portion 31 in the form of an internal gear along the inner periphery thereof. The date cogwheel portion 31 as the calendar cogwheel portion has 31 tooth portions 32. The date indicator 30 has on the annular surface on the dial 4 side a date indication surface portion 36 with dates of from “1” to “31” arranged counterclockwise along the peripheral direction.

The date indicator driving wheel 40 as the calendar driving wheel has a main body portion 43 integrally including a central hub portion 42 equipped with a bearing hole 41, a date indicator driving cogwheel portion 44 integral with the main body portion 43 and in mesh with a cogwheel portion 13a of the hour wheel 13, a date finger portion 46 as a calendar driving finger portion formed at the distal end of an elastic arm portion 45 extending in an arcuate form from the main body portion 43, and a cam portion 50 integral with the hub portion 42; the date indicator driving wheel rotation support shaft portion 23 of the main plate 3 is fit-engaged with the bearing hole 41 so as to allow sliding rotation, enabling rotation around the center axis A at a rotating speed of 1 rotation per day.

Thus, in response to the rotation in the direction C1 of the hour wheel 13 with the passage of time, the date indicator driving wheel 40 in mesh with the hour wheel 13 via the cogwheel portion 13a, 44 is rotated in the direction A1, and is engaged with a tooth portion 32 adjacent to the date cogwheel portion 31 by the date finger 46 once a day, i.e., at the time of date change, causing the date indicator 30 to intermittently rotate one step a day in the direction C1, effecting date feeding to advance by one day the date indicated through a date window (not shown) of the dial 4. Numeral 9 indicates a date indicator maintaining plate.

A cam portion 50 of the date indicator driving wheel 40 has a circular, or cylindrical main cam surface portion 51 whose center is the center axis A of the bearing hole 41, and a recess 52 formed as a torque reduction shape portion radially recessed with respect to the main cam surface portion 51. In the example shown, the recess 52 is equipped with inclined side surfaces 53, 54 and a bottom surface 55.

In this example, the bottom surface 55 is a circular (cylindrical) configuration exhibiting a fixed distance from the center axis A. However, if so desired, it may also be of some other configuration; for example, it may be of a configuration in which the above-mentioned distance is different so as to be maximum or minimum at the center in the peripheral direction, or a configuration in which the maximum diameter portion and the minimum diameter portion are at positions different from the central portion in the peripheral direction or in which there are a plurality of them. Further, while in this example the inclined side surfaces 53, 54 are situated along a radial line (plane) passing the center axis A, it is also possible to adopt, instead, a construction in which, for example, the intermediate portion is curved in a convex or a concave manner or of a further different configuration.

The date jumper support lever 60 as the jumper support lever has a lever main body portion 61 formed as a generally thin and narrow plate, and a thick hub portion 64 equipped with a bearing hole 63 on the lever proximal end portion 62 side of the lever main body portion 61; further, it has a protrusion 65 constituting a cam follower on one side of a somewhat thin-walled distal end portion 66 of the lever main body portion 61. The distal end portion of the protrusion 65 as the cam follower is engaged with the cam portion 50 of the date indicator driving wheel 40 to follow the cam portion 50.

The date jumper support lever 60 is fit-engaged with the date jumper support lever rotation support shaft portion 24 of the main plate 3 at the bearing hole 63 of the hub portion 64, and can make sliding rotation in the directions B1 and B2 around the center axis B of the date jumper support lever rotation support shaft portion 24.

Instead of the main plate 3, the date jumper support lever 60 may be equipped with a shaft-like protrusion (shaft portion corresponding to the date jumper support lever rotation support shaft portion 24), and, instead of the date jumper support lever 60, the main plate 3 may be equipped with a hole portion (hole portion corresponding to the bearing hole 63). Further, a shaft portion or a pin-like portion corresponding to the rotation support shaft portion 24 may be fit-engaged with the holes of the date jumper 60 and of the main plate 3 so as to be rotatable with respect to both the date jumper 60 and the main plate 3.

Thus, in response to the rotation in the direction A1 of the cam portion 50 caused by the rotation in the direction A1 of the date indicator driving wheel 40, the date jumper support lever 60 whose distal end side protrusion 65 is engaged with the cam portion 50 including protrusion and recess due to the main cam surface portion 51 and the recess 52 is rotated in the directions B1 and B2 around the center axis B in accordance with the protrusion and recess.

Further, the date jumper support lever 60 is equipped with a shaft-like protrusion 70 constituting the date jumper rotation support shaft portion in the vicinity of the hub portion 64 of the proximal end portion 62 and on a surface 68 on the side opposite to the dial 4, and is equipped with a protrusion 73 serving as a jumper operating spring shoe portion or spring hook portion on one side edge 72 on a side opposite to the side edge 71 facing the adjacent portion 33 of the date indicator cogwheel portion 31 of the central portion 69 in the longitudinal direction of the lever main body portion 61. As seen in a sectional view of the spring shoe portion 73, a lock surface 74 of the spring shoe portion 73 is substantially of a semi-circular configuration. However, it may somewhat different from a semi-circular configuration.

When the date jumper support lever 60 is at the normal position where it has been rotationally displaced in the direction B2 (the normal position where no date feeding has been effected), the shaft-like protrusion 70 as the date jumper rotation support shaft portion is situated in the vicinity of the inner peripheral edge of the date indicator 30 like the date jumper support lever rotation support shaft portion 24. In this example, in which the date indicator driving wheel rotation support shaft portion 23 is at the 12 o'clock position of the timepiece 2 and in which the date jumper support lever rotation support shaft portion 24 is substantially at a position between 8 o'clock and half past 8 of the timepiece 2, the shaft-like protrusion 70 as the date jumper rotation support shaft portion is substantially at the 9 o'clock position of the timepiece 2.

The date jumper 80 is integrally equipped with a date jumper main body 81 and a jumper spring 86, and is arranged so as to substantially overlap the lever main body portion 61 of the date jumper support lever 60. More specifically, the date jumper main body portion 81 is in the form of a thin and narrow lever 82; a hole portion 83 of a proximal end 82a of the lever 82 is fit-engaged with the protrusion 70 of the support lever 60 so as to be rotatable in the directions D1 and D2 around the center axis D of the protrusion 70, and a jump control finger portion 85 is provided at one side of a distal end 82b. A jumper spring 86 is equipped with a U-shaped or arcuate curved portion 87 and a linear extension portion 88. A proximal end 86a of the jumper spring 86 situated on one end 87a side of the “U-shape” or “arc” of the U-shaped or arcuate curved portion 87 is integrally connected with the proximal end 82a of the lever 82 of the date jumper main body 81, and the other end 87b of the U-shaped or arcuate curved portion 87 is integrally connected with a proximal end 88a of the linear extension portion 88. The linear extension portion 88 extends substantially along one side of the lever 82. One side 89 of the extension end portion 88b of the linear extension portion 88 is elastically pressed against the spring shoe surface or lock surface 74 of the spring shoe portion 73 of the date jumper support lever 60.

Thus, with an abutted portion 89 on one side of the extension end 88b of the jumper spring portion 86 of the main body of the date jumper 80, that is, the date jumper main body 81, being locked to the spring shoe portion 73 of the date jumper support lever 60, the jump control finger portion 85 performs jump control operation on the teeth 32 of the date cogwheel portion 31 of the date indicator 30 under the action of the spring force of the U-shaped jumper spring portion 86.

That is, at the bearing hole portion 83, the date jumper 80 is fit-engaged with the shaft portion 70 of the jumper support lever 60 so as to be rotatable in the directions D1 and D2 while overlapping the lever main body portion 61 of the date jumper support lever 60; it is equipped with the jump control finger portion 85 oriented in the direction B2 opposite to the direction B1 in which the protrusion 65 constituting the cam follower of the jumper support lever 60 is oriented with respect to the rotating directions B1 and B2 of the lever main body portion 61 and the jumper spring portion 86 pressing the jump control finger portion 85 against the date cogwheel portion 31, with the abutted portion 89 on one side of the distal end side end portion 88b of the spring portion 86 being locked to the jumper operating spring shoe portion 73 of the jumper support lever 60.

Thus, simultaneously, with the jump control finger portion 85 of the date jumper 80 being engaged with the date cogwheel portion 31 of the date indicator 30, the jumper spring portion 86 of the date jumper 80 imparts a rotational bias force in the direction B1 to the date jumper support lever 60, causing the protrusion 65 of the date jumper support lever 60 to follow the cam portion 50 of the date indicator driving wheel 40 as the cam follower.

Next, the date feeding operation or calendar feeding operation of the timepiece 2 equipped with the calendar mechanism 1 constructed as described above will be described in more detail with reference to, in addition to FIGS. 1 and 2, FIG. 3A and FIG. 3B through FIG. 8A and FIG. 8B, and FIG. 9.

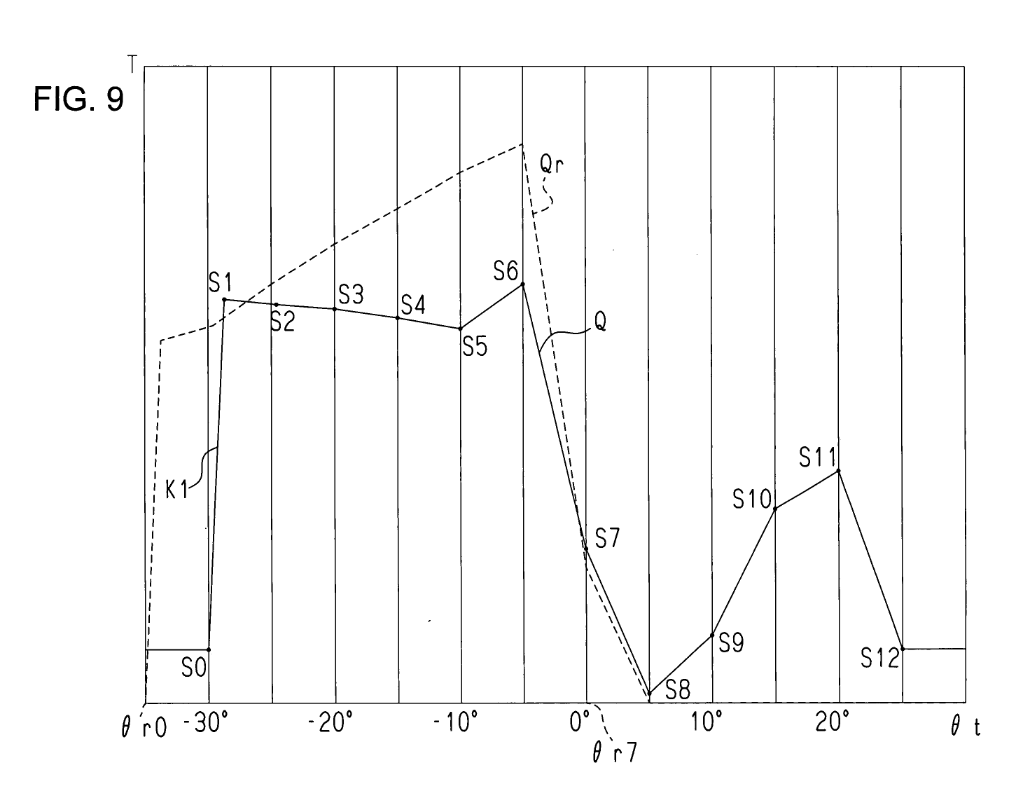

Until the date finger portion 46 reaches position where it is engaged with the cogwheel portion 31 of the date indicator 30, the date indicator driving wheel 40 is rotated in the direction A1 substantially in a non-load state in response to the rotation in the direction C1 of the hour wheel 13. During this substantially non-load rotation of the date indicator driving wheel 40, the date indicator 30 is set by the jump control finger portion 85 of the date jumper 80, with a date being situated just at a predetermined intermittent rotation position in a date window (not shown). FIG. 1 shows this state S0. As indicated by the solid line Q of the graph of FIG. 9, in the state S0, the rotation load torque T of the date indicator driving wheel 40 is very small; it is infinitely small and close to zero.

In this state S0, the load torque T is not zero due to the fact that the friction between the distal end protrusion 65 of the date jumper support lever 60 and the cylindrical cam surface portion 51 of the cam portion 50 of the date indicator driving wheel 40 functions as resistance to the rotation in the direction A1 of the date indicator driving wheel 40. That is, in this state S0, on the one hand, the jumper spring portion 86 sets the date cogwheel portion 31 of the date indicator 30 to impart the requisite force for maintaining the stopping position to the jump control finger portion 85 of the jumper 80, and, on the other hand, imparts, as a reaction, a force to press the distal end protrusion 65 of the date jumper support lever 60 as the cam follower to the cylindrical cam surface portion 51 of the cam portion 50 of the date indicator driving wheel 40, so that the friction between the distal end protrusion 65 of the date jumper support lever 60 and the cylindrical main cam surface portion 51 of the cam portion 50 of the date indicator driving wheel 40 functions as resistance to the rotation in the direction A1 of the date indicator driving wheel 40.

More specifically, FIG. 1 shows a state in which the date finger portion 46 of the date indicator driving wheel 40 just abuts the adjacent tooth portion 32 of the date cogwheel portion 31 of the date indicator 30 and which is immediately before the rotational force in the direction A1 starts to be exerted on the date indicator 30 (the final state of the state S0 of FIG. 9). On the other hand, at this time, the distal end protrusion 65 of the date jumper support lever 60 is situated in the vicinity of the terminal end 56 of the cylindrical main cam surface portion 51 of the cam portion 50 of the date indicator driving wheel 40, in other words, in the vicinity of the upper end 56 of the inlet side inclined surface 53 of the recess 52.

In the state in which the distal end protrusion 65 of the date jumper support lever 60 abuts the cylindrical main cam surface portion 51 of the cam portion 50 of the date indicator driving wheel 40, the rotating direction B1 of the distal end protrusion 65 of the date jumper support lever 60 exactly or substantially coincides with the radial direction of the cylindrical cam surface portion 51. Thus, considering the pressing force of the distal end protrusion 65 that is large to some degree, it is possible to keep the frictional resistance or load torque at low level. Taking into consideration the torque balance around the rotation center B, the length of the arm between the distal end protrusion 65 of the date jumper support lever 60 and the rotation center B is considerably larger than the length of the arm between the jump control finger portion 85 of the date jumper 80 and the rotation center B (approximately two times as large in the example shown), so that the friction between the distal end protrusion 65 serving as the cam follower and the cylindrical cam surface portion 51 of the cam portion 50 is relatively small.

In the state in which the distal end protrusion 65 of the date jumper support lever 60 abuts the cylindrical main cam surface portion 51 of the cam portion 50 of the date indicator driving wheel 40, the date jumper support lever 60 assumes a position where it has been rotated to a maximum degree in the direction B2, and the rotation center D of the date jumper 80 also assumes a position where it has been rotated to a maximum degree in the direction B2. Therefore, the jumper spring 86 presses the jump control finger portion 85 of the date jumper 80 at the setting position against the date cogwheel portion 31 of the date indicator 30 with a maximum spring force to set the rotation of the date indicator 30.

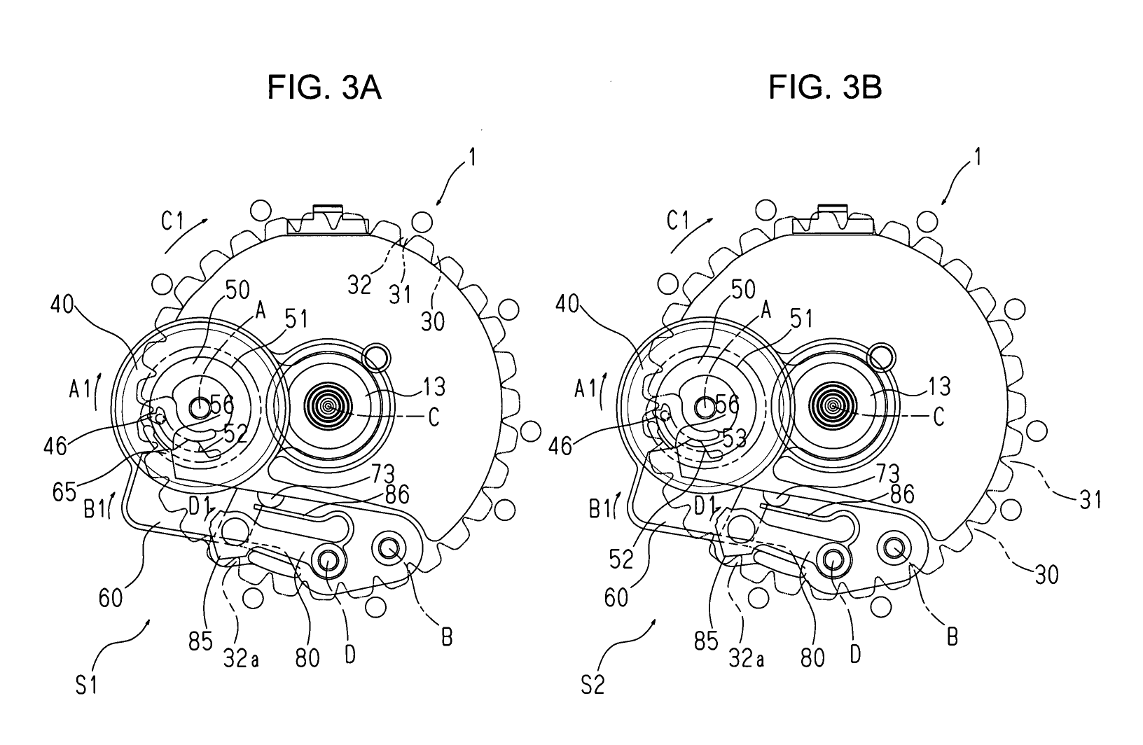

When the date indicator driving wheel 40 is further rotated in the direction A1 from the state S0 shown in FIG. 1 as a result of the rotation of the hour wheel 13, the date finger portion 46 of the date indictor driving wheel 40 is engaged with the adjacent tooth portion 32 of the date cogwheel portion 31 of the date indicator 30, as shown in FIG. 3A, and presses the tooth portion 32 to start to rotate the date indicator 30 in the direction C1. With this, by the tooth portion 32a that has been engaged with the upstream side tooth surface or upstream side inclined surface thereof, the date cogwheel portion 31 of the date indicator 30 starts to push up the jump control finger portion 85 of the date jumper 80 in the direction D1 against the spring force of the jumper spring 86 (state S1 shown in FIG. 3A). Thus, in this state S1, the requisite torque T for the rotation in the direction A1 of the date indicator driving wheel 40 abruptly increases. In FIG. 9, this state S1 is shown, and, at the same time, the abrupt increase in the torque T at the time of transition from the state S0 to the state S1 is indicated by a slope K1.

In the state S1, the distal end of the protrusion 65 of the date jumper support lever 60 has reached a position very close to the terminal end 56 of the cylindrical main cam surface portion 51, that is, a position immediately before the terminal end 56 (However, it has not reached the recess 52 of the cam portion 50).

If so desired, it is also possible for the adjacent tooth portion 32a of the date cogwheel portion 31 to start to push up the jump control finger portion 85 of the date jumper 80 after the distal end of the protrusion 65 of the date jumper support lever 60 has got over the terminal end 56 of the cylindrical main cam surface portion 51 and has started to fall along the side surface 53 of the recess 52. In this case, it is also possible to further reduce the maximum value of the torque T.

Through the rotation of the hour wheel 13 with the passage of time, the date indicator driving wheel 40 is further rotated in the direction A1, causing the date indicator 30 to further rotate in the direction C1. As a result, on the one hand, as described above, the date cogwheel portion 31 of the date indicator 30 pushes up the jump control finger portion 85 of the date jumper 80 in the direction D1 against the spring force of the jumper spring 86 in the engagement tooth portion 32a on the upstream side thereof, and, on the other hand, the distal end protrusion 65 of the date jumper support lever 60 gets over the terminal end 56 of the cylindrical main cam surface portion 51 and starts to be dropped into the recess 52 along the inclined side surface 53 (the state S2 shown in FIG. 3B).

In this state S2, on the one hand, a change occurs so as to increase the torque T in that the jump control finger portion 85 is rotated in the direction D1 against the spring force of the jumper spring 86; on the other hand, however, a change occurs so as to reduce the torque T in that as the distal end protrusion 65 of the date jumper support lever 60 falls into the recess 52 of the cam portion 50 of the date indicator driving wheel 40 along the inclined side surface 53, the date jumper support lever 60 itself is rotated in the direction B1, and, with that, the spring shoe portion 73 of the jumper spring 86 also retreats in the direction B1. That is, in the state S2 shown in FIG. 3B, two tendencies contrary to each other (the tendency to increase the torque T and the tendency to reduce the torque T) overlap each other. That is, regarding the degree of deflection deformation of the jumper spring 86 actually determining the magnitude of the torque T, the deflection deformation of the jumper spring 86 increases through rotation in the direction D1 of the jump control finger portion 85 of the date jumper 80 (The opening side of the “U-shape” is narrowed), and the deflection deformation of the jumper spring 86 is reduced through rotation in the direction B1 of the spring shoe portion 73 of the date jumper support lever 60 (The opening side of the “U-shape” is widened). By selecting the relative arrangement of the rotation centers A, B, and D, the position of the cam portion 50, the configuration (depth, peripheral width, side-surface/bottom-surface configuration) of the recess 52, the configuration of the tooth portion 32 of the date cogwheel portion 31 (depth, the inclination of the inclined side surface, etc.) as desired, it is possible to make these two tendencies approximately of the same degree; for example, as shown in FIG. 9, at the time of change from the state S1 to the state S2, it is possible to make the tendency to reduce the torque greater than the tendency to increase the torque.

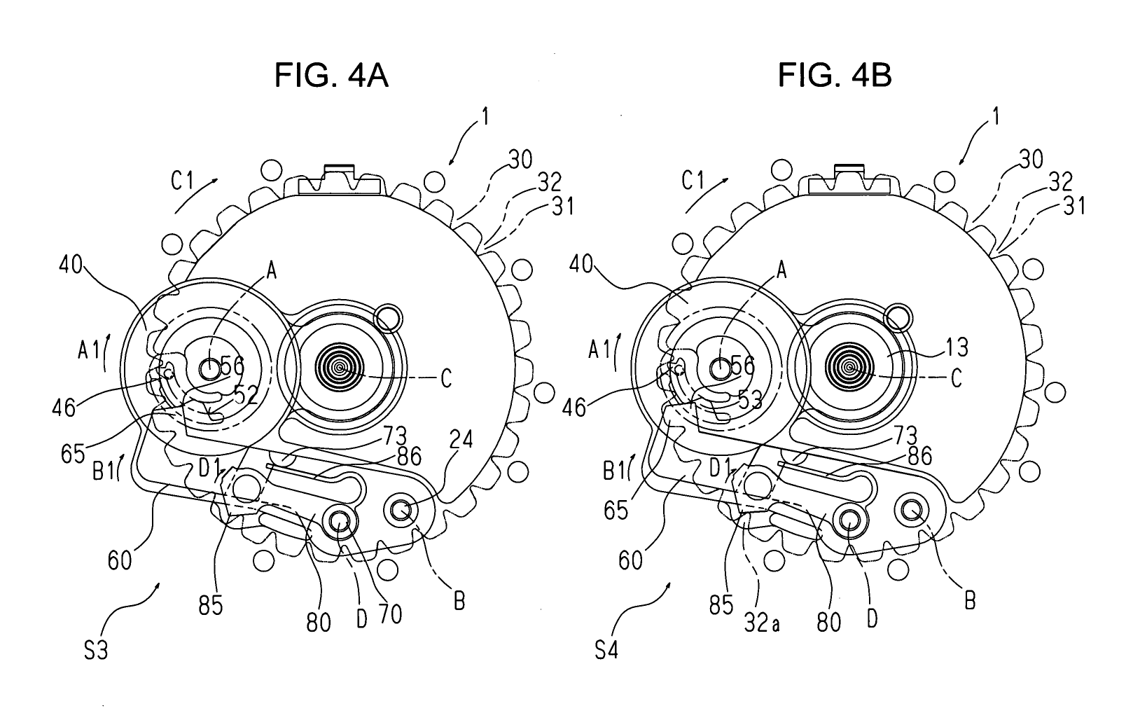

As shown as the states S3 and S4 in FIGS. 4A and 4B, this tendency continues until the distal end protrusion 65 of the date jumper support lever 60 approaches the bottom 55 of the recess 52 as the torque reduction shape portion of the cam portion 50 of the date indicator driving wheel 40.

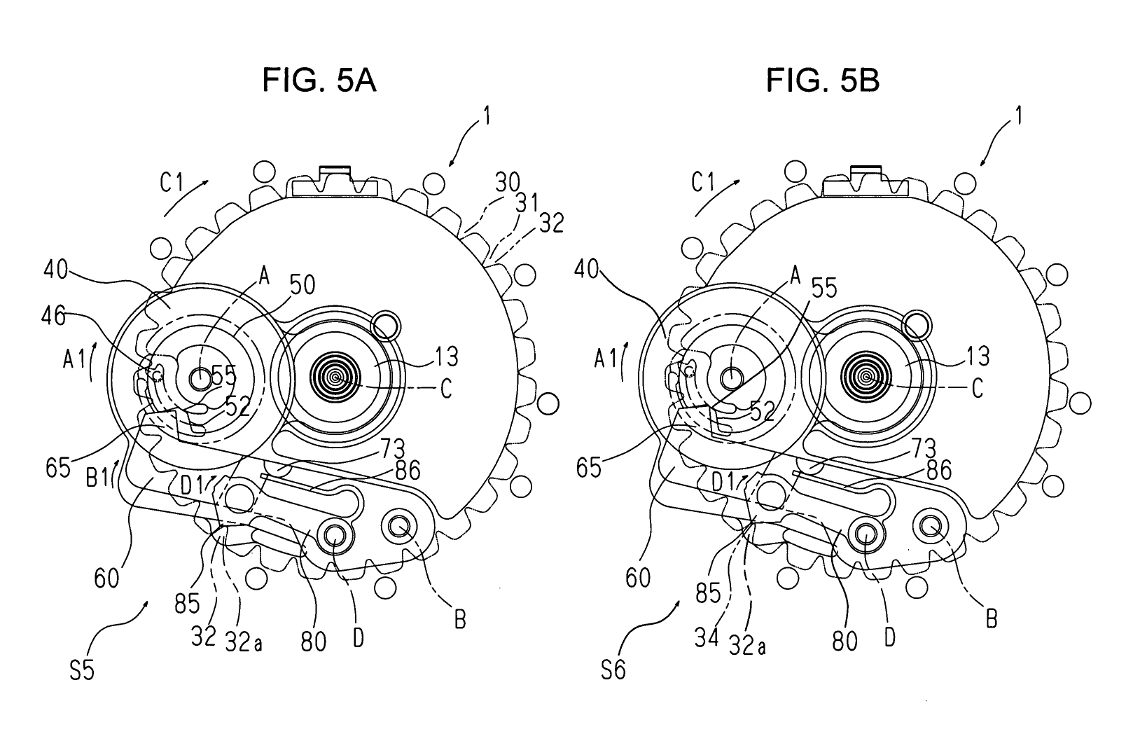

Further, when, with the rotation in the direction A1 of the date indicator driving wheel 40 and the rotation in the direction C1 of the date indicator 30, the distal end protrusion 65 of the date jumper support lever 60 reaches the bottom 55 of the recess 52 of the cam portion 50 of the date indicator driving wheel 40, the torque T assumes minimum value. FIG. 5A shows the state S5 immediately before the distal end protrusion 65 of the date jumper support lever 60 reaches the bottom 55 of the recess 52 of the cam portion 50 of the date indicator driving wheel 40. In FIG. 9, the state S5 is shown as the minimum value state for the sake of convenience.

After the date indicator driving wheel 40 further rotates in the direction A1 and the date indicator 30 further rotates in the direction C1, the distal end protrusion 65 of the date jumper support lever 60 abuts the bottom (the bottom portion cylindrical surface portion) 55 of the recess 52 of the cam portion 50 of the date indicator driving wheel 40, and is maintained in a state in which it is situated along the bottom portion cylindrical surface portion 55 (a state in which it abuts the bottom portion cylindrical surface portion 55). Thus, the date jumper support lever 60 is maintained in an immovable state at a fixed rotating position without being rotated in the direction B1 or B2, and, as the jump control finger portion 85 of the date jumper 80 climbs the inclined side surface of the adjacent tooth portion 32a of the date cogwheel portion 31, the deflection of the jumper spring portion 86 increases, and the torque T increases. As shown as the state S6 in FIG. 5B, this increase in the torque T is practically maximum where the jump control finger portion 85 of the date jumper 80 is very close to the apex 34 of the adjacent tooth portion 32a of the date cogwheel portion 31.

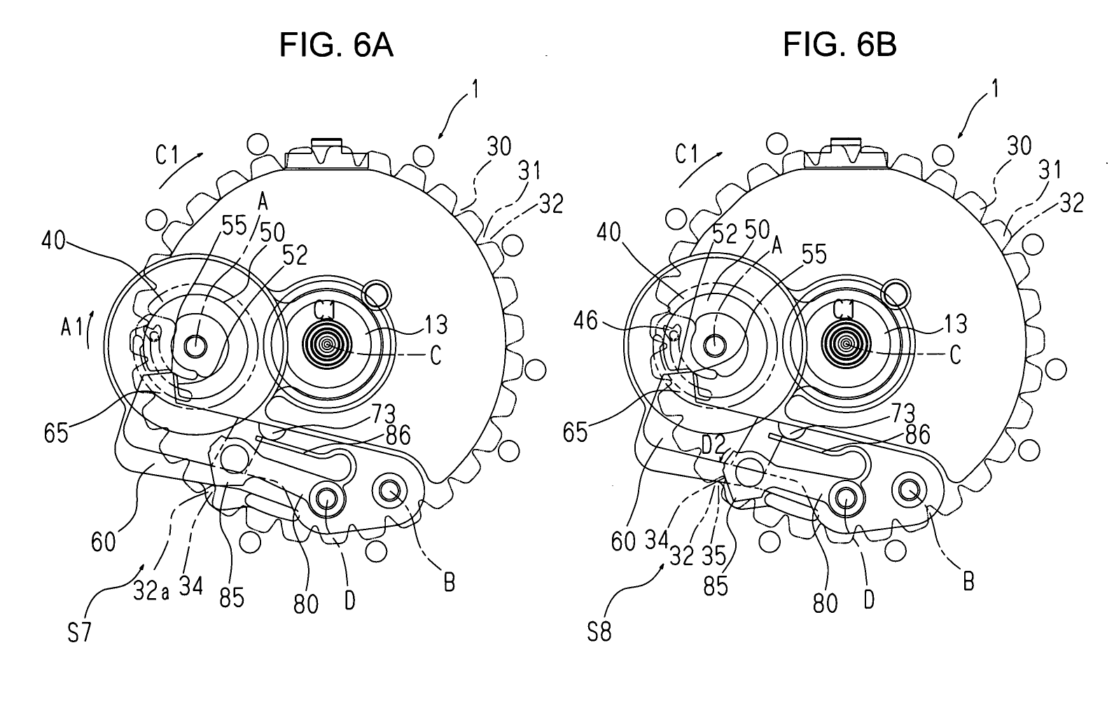

As shown as the state S7 in FIG. 6A, when the date indicator driving wheel 40 further rotates in the direction A1 and the date indicator 30 further rotates in the direction C1, the distal end protrusion 65 of the date jumper support lever 60 continues to be held in contact with the bottom portion cylindrical surface portion 55 of the recess 52 of the cam portion 50, and, with the date jumper support lever 60 being maintained immovable, the jump control finger portion 85 of the date jumper 80 reaches the apex 34 of the adjacent tooth portion 32a of the date cogwheel portion 31, and the rotation in the direction D1 of the date jumper 80 is also stopped, with the load torque T being abruptly reduced. In this state S7, the value of the horizontal axis in FIG. 9 is 0°, and a rapid intermittent rotation of the date indicator 30 starts in order to effect date feeding to advance the date indicated in the date window (not shown) by one day.

When it gets over the apex 34 of the engagement tooth portion 32a of the date cogwheel portion 31, the jump control finger portion 85 of the date jumper 80 presses the inclined surface 35 at the rear of the engagement tooth portion 32a while being rotation-displaced in the direction D2 by the spring force of the jumper spring 86, causes the date cogwheel portion 31 to rotate in the direction C1, and falls between the next tooth portions 32, 32 of the date cogwheel portion 31, setting the date indicator 30. At this falling of the jump control finger portion 85 of the date jumper 80, the indicator 30 is rotated abruptly, and the date feeding is completed when the jump control finger portion 85 reaches the setting position. As shown as the state S8 in FIG. 6B, with the abrupt rotation of the date indicator 30, the tooth 32 of the date cogwheel portion 31 of the date indicator 30 is detached from the date finger portion 46 of the date indicator driving wheel 40. Meanwhile, the protrusion 65 of the date jumper support lever 60 is kept in contact with the cylindrical bottom surface 55 of the recess 52 of the cam portion 50, and the date jumper support lever 60 is kept at a fixed rotating position around the center axis B. In the state S8 of FIG. 6B, as compared with the state S0 of FIG. 1, the bending load of the jumper spring 86 is smaller, so that the frictional resistance to the rotation of the date indicator driving wheel 40 is less. Thus, as shown in FIG. 9, in this state S8, the torque T is minimum.

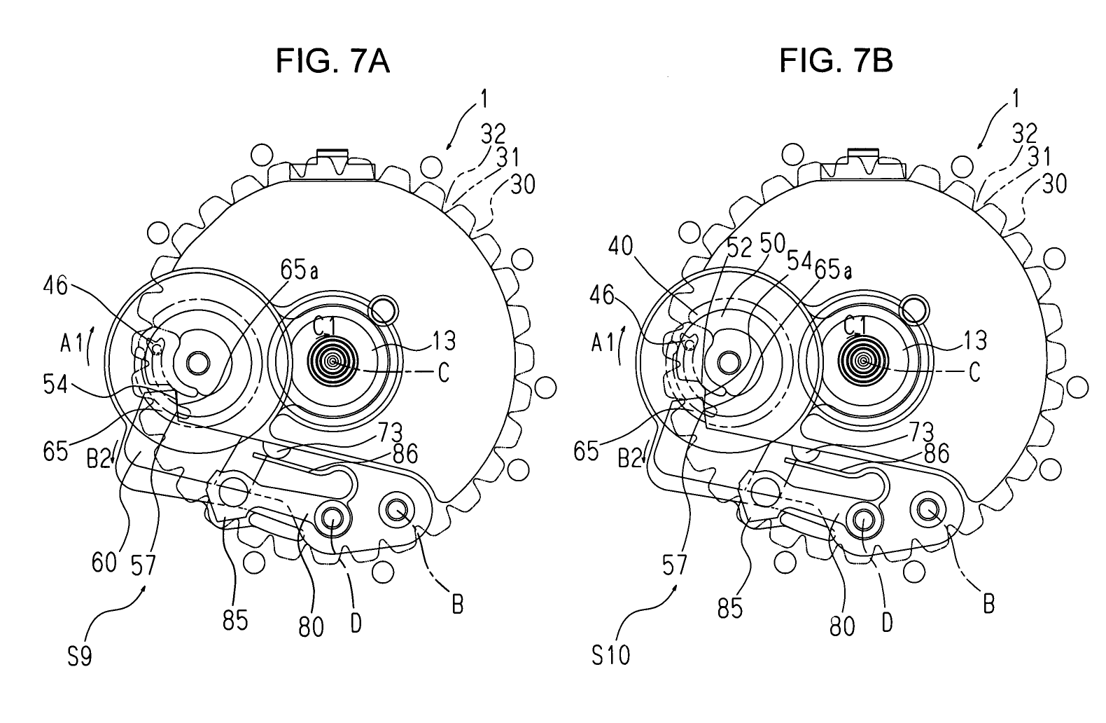

After this, as shown as the state S9 in FIG. 7A, as the date indicator driving wheel 40 rotates in the direction A1 in response to the rotation in the direction C1 of the hour wheel 13 with the passage of time, the side edge 65a of the protrusion 65 of the date jumper support lever 60 abuts the inclined surface 54 of the recess 52 of the cam portion 50 of the date indicator driving wheel 40, and, further, the protrusion 65 of the date jumper support lever 60 starts to climb the inclined surface 54 of the recess 52 of the cam portion 50 of the date indicator driving wheel 40. At this time, the protrusion 65 of the date jumper support lever 60 is rotated in the direction B2 while deflecting the spring 86 against the spring force of the jumper spring 86 of the date jumper 80. In response to the rotation in the direction B2 of the protrusion 65 of the date jumper support lever 60, the spring shoe portion 73 under the spring force of the jumper spring 86 is also rotated in the direction B2 to impart the load torque T with respect to the rotation of the date indicator driving wheel 40, and the torque T increases to some degree as shown in FIG. 9. At this time, the jump control finger portion 85 of the date jumper 80 keeps setting the cogwheel portion 31 of the date indicator 30.

After this also, as shown as the state S10 in FIG. 7B, as the date indicator driving wheel 40 rotates in the direction A1 in response to the rotation in the direction C1 of the hour wheel 13, the protrusion 65 of the date jumper support lever 60 continues to climb the inclined surface 54 of the recess 52 of the cam portion 50 of the date indicator driving wheel 40 while rotated in the direction B2 against the spring force of the jumper spring 86 of the date jumper 80 (More specifically, in the example shown, the protrusion 65 of the date jumper support lever 60 comes out of the recess 52, with the side edge 65a thereof being in contact with the upper end portion (the portion crossing the cylindrical main cam surface portion 51) of the inclined surface 54. The load torque T with respect to the rotation in the direction A1 of the date indicator driving wheel 40 due to the spring force of the jumper spring 86 increases; however, as can be seen from FIG. 9, as compared with the states before the date jumper 80 gets over the tooth 32 of the date cogwheel portion 31 (the states S1 through S6), the load torque T thereof is small. The date jumper 80 is kept in the state in which the jump control finger portion 85 sets the cogwheel portion 31 of the date indicator 30.

Here, the load torque T may be relatively small for the following reasons: the arm length from the center axis B to the protrusion 65 of the date jumper support lever 60 is larger than the arm length from the center axis B to the jump control finger portion 85 of the date jumper 80 (In this example, the former is approximately two times as large as the latter, and is approximately three times as large as the arm length from the center axis D to the jump control finger portion 85 of the date jumper 80 (However, it may be larger or somewhat smaller than that)); if, to facilitate its production, the recess 52 of the cam portion 50 is considerably deep, it is possible to keep the load torque T at a relatively low level; further, the inclination of the side edge 65a of the protrusion 65 of the date jumper support lever 60 (or the inclination of the inclined surface 54 of the recess 52 of the cam portion 50) is relatively small.

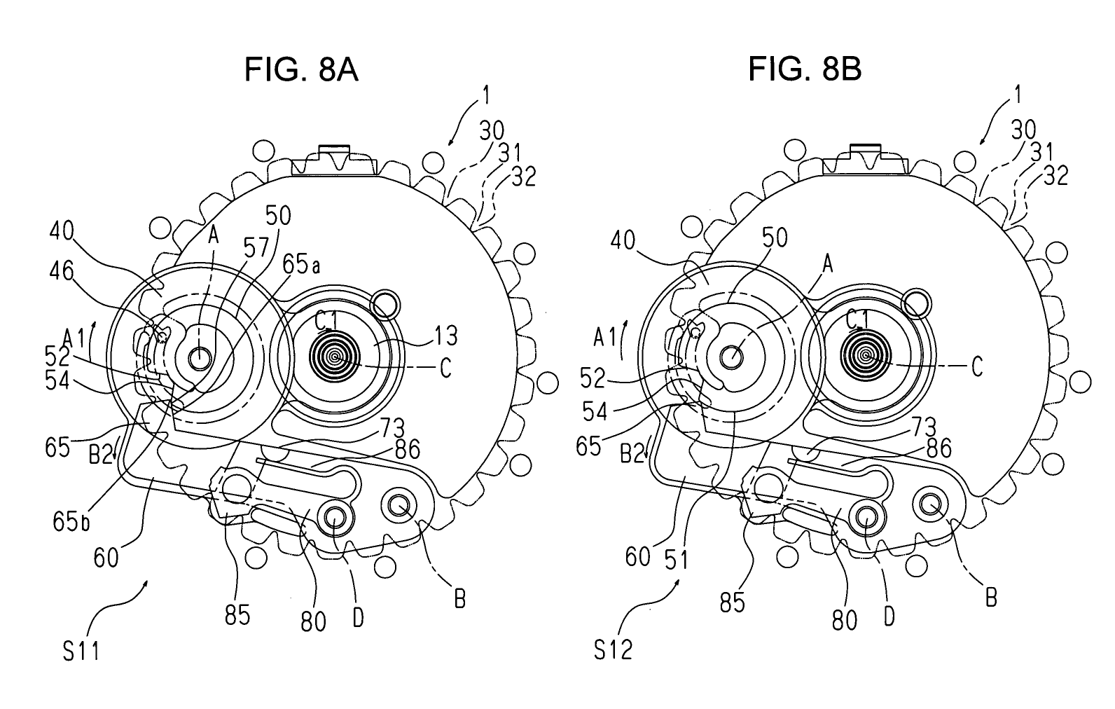

Further, as shown as the state S11 in FIG. 8A, as the date indicator driving wheel 40 rotates in the direction A1 in response to the rotation in the direction C1 of the hour wheel 13, the protrusion 65 of the date jumper support lever 60 strives to climb to the top of the inclined surface 54 of the recess 52 of the cam portion 50 of the date indicator driving wheel 40 while rotated in the direction B2 against the spring force of the jumper spring 86 of the date jumper 80 (More specifically, as described above, in the example shown, the distal end 65b of the protrusion 65 strives to reach the upper end portion 57 of the inclined surface 54, with the side edge 65a of the protrusion 65 of the date jumper support lever 60 being in contact with the upper end portion 57 of the inclined surface 54). At this time, the load torque T with respect to the rotation in the direction A1 of the date indicator driving wheel 40 caused by the jumper spring 86 is practically maximum. However, as described above, as can be seen from FIG. 9, as compare with the states in which the date jumper 80 strives to get over the tooth 32 of the date cogwheel portion 31 (the states S1 through S6), the load torque T thereof is considerably smaller. Similarly, the date jumper 80 is kept in the state in which the jump control finger portion 85 sets the cogwheel portion 31 of the date indicator 31.

Further, as shown as the state S12 in FIG. 8B, as the date indicator driving wheel 40 rotates in the direction A1 in response to the rotation in the direction C1 of the hour wheel 13, when the protrusion 65 of the date jumper support lever 60 comes to abut the arcuate or partially cylindrical main cam surface portion 51 after it has climbed to the top of the inclined surface 54 of the recess 52 of the cam portion 50, the rotating position around the center axis B of the date jumper support lever 60 is kept fixed even if the date indicator driving wheel 40 rotates. Thus, the date jumper support lever 60 is kept at a fixed position around the center axis B. On the other hand, the date jumper 80 is kept in the state in which the jump control finger portion 85 sets the cogwheel portion 31 of the date indicator 30. Thus, the load torque T with respect to the rotation in the direction A1 of the date indicator driving wheel 40 is reduced to a low level and kept at a fixed value at this level. As far as the load torque T is concerned, the state S 12 is the same as the state S0 shown in FIG. 1. However, as compared with the state S8 of FIG. 6B, in this state S12, the load torque T attributable to the frictional force is so much the larger (if to some degree) because the protrusion 65 of the date jumper support lever 60 abuts not the bottom 54 of the recess 52 of the cam portion 50 but the main cam surface portion 51 to enhance the spring load of the jumper spring 86.

In the operation of the calendar mechanism 1 as described above, the movement or displacement of the jump control finger portion 85 of the date jumper 80 and the movement or displacement of the protrusion 65 of the date jumper support lever 60 are both effected by the spring force of the jumper spring 86. Furthermore, in particular, at the time of operation of this calendar mechanism 1, the date jumper 80 is placed on the date jumper support lever 60, and is scanned in the directions D1 and D2 within the range of scanning in the directions B1 and B2 of the date jumper support lever 60, so that, when operating the calendar mechanism 1, it is possible to minimize the occupation area. Thus, it is possible to leave the remaining region for the various functions and various displays of the timepiece 2.

In the above construction, in the case where the other conditions are fixed, for example, when the recess 52 of the cam portion 50 becomes deeper, the load torque T during the states S1 through S6 is further reduced on the one hand, and, on the other hand, the load torque T during the states S10 and S11 is further increased. So long as the facility with which the protrusion and recess configuration of the cam portion 50 is produced can be secured, if, for example, the arm length of the date jumper support lever 60 is reduced to some degree, it is possible to attain substantially the same effect as far as this point is concerned.

As described above, in FIG. 9, the change in the load torque T in the calendar mechanism 1 of the timepiece 2 is indicated by the solid line Q. Here, the horizontal axis et indicates the rotating position of the hour hand 16 or the hour wheel 13; it is 0 degrees at the point in time when the hour hand 16 indicates 0 o'clock. Thus, in the solid line Q of FIG. 9 indicating the change in the load torque T of the calendar mechanism 1 of the timepiece 2, the point in time corresponding to the date feeding state S7 is 0 degrees.

In FIG. 9, the broken line Qr indicates a comparative example in which the position of the spring shoe supporting the spring portion of the date jumper does not fluctuate but is kept at a fixed position (a case where there is no date jumper support lever rotatable with respect to the main plate and where the spring shoe is formed on a support substrate like a main plate (At this time, the date jumper is also rotatably supported on the support substrate)). In the case of this comparative example, as indicated by the broken line Qr, when the jump control finger portion of the date jumper gets over the tooth portion of the date cogwheel portion of the date indicator, the spring shoe does not escape, so that the load torque is high (See the state substantially corresponding to the states S2 through S6 indicated by the solid line Q). In other words, in the calendar mechanism 1 of this timepiece 2, the load torque T is small.

By nature, the load torque T depends on the configuration of the jump control finger portion 85 of the date jumper 80 and the configuration of the tooth portions 32, 32 of the cogwheel portion 31 of the date indicator 30; however, in a case, for example, in which the configuration of the jump control finger portion 85 of the date jumper 80 and the configuration of the tooth portions 32, 32 of the cogwheel portion 31 of the date indicator 30 are not changed, by changing, using the rotation center B as a reference, the ratio of the arm length to the protrusion 65 of the date jumper support lever 60 and of the arm length to the jump control finger portion 85 of the date jumper 80, the configuration of the side edge of the protrusion 65, the configuration of the recess 52 of the cam portion 50, etc., it is possible to change the degree to which the load torque t is reduced.

When the point in time of date feeding is 0 degrees and is used as a reference, in the calendar mechanism 1 of the timepiece 2, not only is the spring shoe 73 rotated in the direction B1 in response to the rotation in the direction B1 of the date jumper support lever 60 caused by one rotation in the direction C1 of the date indicator 30, but the rotation center D1 is also rotated in the direction B1, so that the jump control finger portion 85 of the date jumper 80 is also rotated to some degree in the direction B1 around the center axis B. That is, not only is the jump control finger portion 85 of the date jumper 80 rotated in the direction D1 as the date indicator 30 rotates in the direction C1, but also the protrusion 65 of the date jumper support lever 60 is fitted into the recess 52 of the cam portion 50 as the date indicator 30 rotates in the direction C1, and the date jumper support lever 60 rotates in the direction B1, whereby the jump control finger portion 85 of the date jumper 80 is simultaneously rotated in the direction B1 (In other words, the effective rotation in the direction D1 of the jump control finger portion 85 of the date jumper 80 further increases), so that the speed at which the jump control finger portion 85 gets out from between the tooth portions 32, 32 of the date cogwheel portion 31 increases. Thus, assuming that the point in time θt for date feeding is 0 degrees and is used as a reference, the period of time from the point in time when the raising of the jump control finger portion 85 is started in the operation Q (indicated by the solid line) of the calendar mechanism 1 of the timepiece 2 to the completion of date feeding (which, in the case of this example, is substantially between the final stage of the state S0 and the state S7) is shorter as compared with the period of time from the point in time θr0 when the raising of the jump control finger portion is started to the date feeding completion θr7 of the operation Qr (indicated by the broken line) of the comparative example, in which the position of the spring shoe is kept immovable. Therefore, even when the configuration of the tooth portions of the date cogwheel portion of the date indicator is the same, the configuration of the jump control finger portion of the date jumper, for example, may be somewhat different.

As can be seen from the comparison of the lines Q and Qr, in the comparative example Qr, a large load torque T is concentrated in a short period of time, and the load torque T is close to zero in the remaining period, whereas, in the calendar mechanism 1 of the timepiece 2, the load torque T is relatively low and is generally dispersed.

Thus, in the calendar mechanism 1, there is no need for a large support structure (high solidity) withstanding a large power drive source and large rotation load corresponding to the maximum value of the load torque T. From another point of view, in the calendar mechanism 1, it is possible to keep the load torque T at the time of driving the date indicator at a relatively low level, so that even when applied to a timepiece exhibiting not only date display but also day display, it is also possible to perform day feeding of the day indicator with the same timing as that of the date feeding of the date indicator (the point in time of 0 degrees in FIG. 9).

Further, while in the above-described example the rotation center D of the date jumper 80 is different from the rotation center B of the date jumper support lever 60, it is also possible for the rotation center D of the date jumper 80 to coincide with the rotation center B of the date jumper support lever 60. In this case, instead of supporting the date jumper 80 directly and rotatably by the date jumper support lever 60, it is also possible for the respective bearing hole portions of both the date jumper support lever and the date jumper to be rotatably fit-engaged, for example, with the shaft-like protrusion protruding from the main plate. As is always the case with relative rotation, the shaft portion may be on the date jumper support lever or the date jumper and the bearing support hole portions may be in the other two members. When the rotation center of the date jumper and the rotation center of the date jumper support lever thus coincide with each other, the maximum value of the jump control force due to the date jumper is reduced; however, the period of time that the date jumper performs jump operation is practically the same as the period of time (θr7-θr0) in the case of the comparative example Qr.

While in the above-described example the calendar mechanism is applied to date display, it is also applicable to day display, etc.

What is claimed is:

1. A calendar mechanism comprising:
a calendar wheel equipped with a calendar cogwheel portion;
a calendar driving wheel equipped with a calendar finger portion rotating the calendar cogwheel portion and a cam portion rotating coaxially with the finger portion;
a jumper support lever equipped with a lever main body portion whose lever proximal end portion is rotatably supported on a substrate, a cam follower portion formed on one side of a distal end portion of the lever main body portion and following the cam portion, and a jumper operating spring shoe portion provided in an intermediate portion between a distal end portion and a proximal end portion in the longitudinal direction of the lever main body portion, with the cam follower portion and the jumper operating spring shoe portion being formed on the same side of the lever main body portion with respect to the rotating direction of the lever main body portion; and
a jumper arranged so as to be rotatable with respect to the jumper support lever while overlapping the lever main body portion of the jumper support lever, the jumper being equipped with a jump control finger portion directed in a direction opposite to the cam follower portion of the jumper support lever with respect to the rotating direction of the lever main body portion and engaged with the calendar cogwheel portion and a jumper spring portion pressing the jump control finger portion against the calendar cogwheel portion, a distal end side end portion of the spring portion of the jumper being locked to the jumper operating spring shoe portion of the jumper support lever,
wherein the cam portion of the calendar driving wheel is equipped with a torque reduction shape portion so as to reduce the spring load of the jumper spring portion when the jump control finger portion of the jumper gets over a tooth portion constituting the calendar cogwheel portion.

2. A calendar mechanism according to claim 1, wherein the jumper support lever is equipped with a jumper rotation support portion; and the jumper is rotatably supported by the jumper rotation support portion of the jumper support lever.

3. A calendar mechanism according to claim 2, wherein the jumper support lever is equipped with a jumper rotation support portion in the vicinity of the proximal end portion of the lever main body portion, and is equipped with a jumper operating spring shoe portion in an intermediate portion between the distal end portion of the lever main body portion and the jumper rotation support portion with respect to the longitudinal direction of the lever; and the jumper is equipped with a jump control finger portion between the distal end portion and the proximal end portion of the lever main body portion with respect to the longitudinal direction of the lever main body portion and on a side opposite to the jumper operating spring shoe portion with respect to the width direction of the lever main body portion.

4. A calendar mechanism according to claim 3, wherein the jumper is equipped with a thin and narrow jumper main body portion, and is rotatably supported by the jumper rotation support portion at the distal end portion of the jumper main body portion; the jumper spring portion is curved in a U-shape from the proximal end portion of the jumper main body and extends along one side portion of the jumper main body portion; and the jump control finger portion is formed at the other side portion of the distal end portion of the jumper main body.

5. A calendar mechanism according to claim 2, wherein the cam portion is equipped with a partial annular surface portion, and a recess recessed radially and inwardly from the annular surface portion to function as the torque reduction shape portion; and when the jump control finger portion of the jumper climbs an apex of one tooth portion of the calendar cogwheel portion, the cam follower portion of the jumper support lever is fitted into the recess of the cam portion.

6. A calendar mechanism according to claim 3, wherein the cam portion is equipped with a partial annular surface portion, and a recess recessed radially and inwardly from the annular surface portion to function as the torque reduction shape portion; and when the jump control finger portion of the jumper climbs an apex of one tooth portion of the calendar cogwheel portion, the cam follower portion of the jumper support lever is fitted into the recess of the cam portion.

7. A calendar mechanism according to claim 4, wherein the cam portion is equipped with a partial annular surface portion, and a recess recessed radially and inwardly from the annular surface portion to function as the torque reduction shape portion; and when the jump control finger portion of the jumper climbs an apex of one tooth portion of the calendar cogwheel portion, the cam follower portion of the jumper support lever is fitted into the recess of the cam portion.

8. A calendar mechanism according to claim 5, wherein after the jump control finger portion of the jumper has started to climb one tooth portion of the calendar cogwheel portion, the cam follower portion of the jumper support lever starts to be fitted into the recess of the cam portion.

9. A calendar mechanism according to claim 6, wherein after the jump control finger portion of the jumper has started to climb one tooth portion of the calendar cogwheel portion, the cam follower portion of the jumper support lever starts to be fitted into the recess of the cam portion.

10. A calendar mechanism according to claim 7, wherein after the jump control finger portion of the jumper has started to climb one tooth portion of the calendar cogwheel portion, the cam follower portion of the jumper support lever starts to be fitted into the recess of the cam portion.

11. A calendar mechanism according to claim 5, wherein after the jump control finger portion of the jumper has completely got over one tooth portion of the calendar cogwheel portion and is fitted into the interval between the next pair of tooth portions to complete the setting of the calendar cogwheel portion, the cam follower portion of the jumper support lever starts to escape from the recess of the cam portion.

12. A calendar mechanism according to claim 6, wherein after the jump control finger portion of the jumper has completely got over one tooth portion of the calendar cogwheel portion and is fitted into the interval between the next pair of tooth portions to complete the setting of the calendar cogwheel portion, the cam follower portion of the jumper support lever starts to escape from the recess of the cam portion.

13. A calendar mechanism according to claim 7, wherein after the jump control finger portion of the jumper has completely got over one tooth portion of the calendar cogwheel portion and is fitted into the interval between the next pair of tooth portions to complete the setting of the calendar cogwheel portion, the cam follower portion of the jumper support lever starts to escape from the recess of the cam portion.

14. A calendar mechanism according to claim 1, wherein the calendar wheel and the calendar cogwheel portion are a date indicator and a date cogwheel portion, respectively; the calendar driving wheel and the calendar finger portion are a date indicator driving wheel and a date finger portion, respectively; the jumper support lever and the jumper operating spring shoe portion are a date jumper support lever and a date jumper operating spring shoe portion, respectively; and the jumper is a date jumper.

15. A calendar mechanism according to claim 2, wherein the calendar wheel and the calendar cogwheel portion are a date indicator and a date cogwheel portion, respectively; the calendar driving wheel and the calendar finger portion are a date indicator driving wheel and a date finger portion, respectively; the jumper support lever and the jumper operating spring shoe portion are a date jumper support lever and a date jumper operating spring shoe portion, respectively; and the jumper is a date jumper.

16. A calendar mechanism according to claim 3, wherein the calendar wheel and the calendar cogwheel portion are a date indicator and a date cogwheel portion, respectively; the calendar driving wheel and the calendar finger portion are a date indicator driving wheel and a date finger portion, respectively; the jumper support lever and the jumper operating spring shoe portion are a date jumper support lever and a date jumper operating spring shoe portion, respectively; and the jumper is a date jumper.

17. A calendar mechanism according to claim 4, wherein the calendar wheel and the calendar cogwheel portion are a date indicator and a date cogwheel portion, respectively; the calendar driving wheel and the calendar finger portion are a date indicator driving wheel and a date finger portion, respectively; the jumper support lever and the jumper operating spring shoe portion are a date jumper support lever and a date jumper operating spring shoe portion, respectively; and the jumper is a date jumper.

18. A calendar mechanism according to claim 5, wherein the calendar wheel and the calendar cogwheel portion are a date indicator and a date cogwheel portion, respectively; the calendar driving wheel and the calendar finger portion are a date indicator driving wheel and a date finger portion, respectively; the jumper support lever and the jumper operating spring shoe portion are a date jumper support lever and a date jumper operating spring shoe portion, respectively; and the jumper is a date jumper.

19. A calendar mechanism according to claim 6, wherein the calendar wheel and the calendar cogwheel portion are a date indicator and a date cogwheel portion, respectively; the calendar driving wheel and the calendar finger portion are a date indicator driving wheel and a date finger portion, respectively; the jumper support lever and the jumper operating spring shoe portion are a date jumper support lever and a date jumper operating spring shoe portion, respectively; and the jumper is a date jumper.

20. A timepiece equipped with a calendar mechanism according to claim 1.
